(19) United States
(12) Patent Application Publication
(10) Pub. No.: US 2011/0248019 A1
(43) Pub. Date: Oct. 13, 2011

(54) METHOD FOR TREATING HYDROCARBON FLUIDS USING PULSATING ELECTROMAGNETIC WAVE IN COMBINATION WITH INDUCTION HEATING

(76) Inventor: Hwee Hong Chew, Singapore (SG)

(21) Appl. No.: 13/140,833

(22) PCT Filed: Dec. 18, 2008
(86) PCT No.: PCT/CN08/73575

§ 371 Date: Jun. 18, 2011

(51) Int. Cl. H05B 6/02

(52) U.S. Cl. 219/600

(57) ABSTRACT

A method for treating hydrocarbon fluids using pulsating electromagnetic wave in combination with induction heating is provided, which comprise the steps of mounting an induction coil onto a conduit having a central axis from which the hydrocarbon fluid to be treated flows, the induction coil being coaxially disposed with the conduit and having an inner diameter which forms a predetermined gap with an outer periphery of the conduit; subjecting the hydrocarbon fluid through the conduit; and applying a time-varying frequency current to the induction coil to produce pulsating electromagnetic field and induction heating around the induction coil, such that the combined effect of the pulsating electromagnetic field and the induction heating is induced in the fluid to prevent and/or reduce build-up of or natural deposition of paraffin, asphaltene or the like contained in the fluid and reduce a viscosity of the fluid in production lines, flow transmission lines, pipelines and oil storage.

### FIELD OF THE INVENTION

The present invention relates to the treatment of hydrocarbon fluids, and more particularly, to a method for treating hydrocarbon fluids using pulsating electromagnetic wave in combination with induction heating.

### BACKGROUND OF THE INVENTION

Treatment of hydrocarbon fluids having contaminants or components such as paraffin, asphaltene or the like is necessary in order that the fluids provide a more useful purpose. The fluids are also treated in order to increase the flow rate of the fluids, optimize one or more physical parameters of the fluids or the like.

It is well known in the prior art that paraffin, asphaltene or the like are commonly found in most crude oils. It is also well known that these components tend to form deposits in pipelines located in oil fields, oil transmission and refining operations. These deposits are a hindrance to the flow of the fluids, thereby adversely affect the production in the oil industry.

Paraffins comprise straight-chain or branched-chain alkanes of relatively high molecular weight, and asphaltenes comprise dark brown to black components present in crude oil with a relatively high molecular weight. It was reported that asphaltenes consist of condensed aromatic nuclei that carry alkyl and alicyclic structure with heterocyclic atoms, i.e., nitrogen, oxygen, sulfur, scattered throughout. Based upon observations of this structure, it is believed that asphaltene particles form and behave like colloids. It is well known that colloidal particles remain suspended so long as equilibrium between the particulate phase and the solvent phase is maintained. If, however, the equilibrium conditions change even slightly, they may precipitate from the solvent phase of the crude oil. It has been reported that the decrease in temperature is the major factor that causes this precipitation.

Typically, some of the prior art systems employ hot oil, hot water or chemical solvents that are pumped through tubing into the wellbore to either melt or dissolve the deposition and build up of paraffin, asphaltene and scale on the inside of the crude oil line from which the crude oil flows and on the surface of flow transmission lines. However, these prior art system result in substantial down time and costs in terms of heating a sufficient amount of water or oil.

To this end, a number of methods and systems using electromagnetic fields have been proposed for the removal or reduction of the amount of paraffin deposits resulting from the transmission of crude oil. For example, U.S. Pat. No. 5,899,220 discloses an electromagnetic fluid conditioning apparatus and method which inhibit the build-up of, the formation of, and the deposition of paraffin, asphaltene or the like using a single fixed non-time varying AC current. In the above patent U.S. Pat. No. 5,899,220, a high intensity magnetic field is required to produce molecular polarization wherein minimum magnetic field intensity is 50 gauss and the treatment effect is associated with the applied electromagnetic field intensity. However, when this invention is used industrially for a typical fuel oil combustion plant, and particularly when used singularly, this treatment method has a low efficiency.

Moreover, in the case of the stationary oil storage, there occurs a “gumming” problem which needs to be solved.

Accordingly, the present invention intends to address these limitations and disadvantages of the prior art by providing an improved method for treating hydrocarbon fluids using pulsating electromagnetic wave in combination with induction heating. The method of the invention is useful for preventing and reducing the build-up of, the formation of, and the deposition of paraffin, asphaltene or the like in pipelines or the like.

### SUMMARY OF THE INVENTION

The present invention is made in consideration of the above. It is an object of the present invention to provide a method for treating hydrocarbon fluids using pulsating electromagnetic wave in combination with induction heating. The method in accordance with the invention allows to efficiently reduce the strength of the physiosorption interaction between the paraffin or asphaltene molecules and the walls of the pipe through the action of pulsating electromagnetic field as well as to quickly produce induction heating so that the required temperature is reached, enabling to reduce the oil viscosity. Obviously, the invention takes advantage of combined use of electromagnetic fields with induction heating.

In order to achieve the foregoing object, the present invention provides a method for treating a hydrocarbon fluid using pulsating electromagnetic wave in combination with induction heating, comprising the steps of:
(a) mounting an induction coil onto a conduit having a central axis from which the hydrocarbon fluid to be treated flows, the induction coil being coaxially disposed with the conduit and having an inner diameter which forms a predetermined gap with an outer periphery of the conduit;
(b) subjecting the hydrocarbon fluid through the conduit; and
(c) applying a time-varying frequency current to the induction coil to produce pulsating electromagnetic field and induction heating around the induction coil, such that the combined effect of the pulsating electromagnetic field and the induction heating is induced in the fluid to prevent and/or reduce build-up of or natural deposition of paraffin, asphaltene or the like contained in the fluid and reduce a viscosity of the fluid in production lines, flow transmission lines, pipelines and oil storage.

In one preferred embodiment of the invention, the conduit is made of a metal material, such as stainless steel 316L.

Preferably, the induction coil helically surrounds the conduit, the number of turns of the coil is in the range of 2 to 2000, and preferably in the range of 150 to 180.

It is preferable that the induction coil is made of copper wire having an outer diameter from 1 to 10 mm, preferably from 2 to 5.5 mm.

It is preferable that an insulating layer is applied to an inner surface of the induction coil and/or an outer surface of the conduit on which the coil is disposed to create the gap.

The time-varying frequency current may be supplied by a pulse powered time-varying frequency generator, or an analog or digital control circuit. The generator disclosed in Chinese patent CN 200310100334.8 can be used in this invention. It is preferable that the generator is connected to a DC Voltage source to which a mains power supply is converted by means of a rectifier circuit. The DC Voltages preferably range from 3 to 48 volts.

It is preferable that the time-varying frequency has a sweeping timing varying from lms to 10 sec.

It is preferable that the time-varying frequency wave is square, triangular or sinusoidal.

As explained above, the method of the invention enables to effectively prevent and/or reduce the build-up of, the formation of, and the deposition of paraffin, asphaltene or the like in pipelines because the combined effects of electric field, magnetic field and heating take place.

### BRIEF DESCRIPTION OF THE DRAWINGS

Additional features of the present invention will be more apparent from the following detailed description and appended claims when taken in conjunction with the drawings, in which:

FIG. 1 is a diagram showing a general arrangement of one embodiment of the present invention; and

FIG. 2 is a curve chart showing a relationship between the viscosity (cP) of heavy oil and temperature (° C.).

### DETAILED DESCRIPTION OF THE PREFERRED EMBODIMENTS

The present invention will now be described in detail with reference to the drawings.

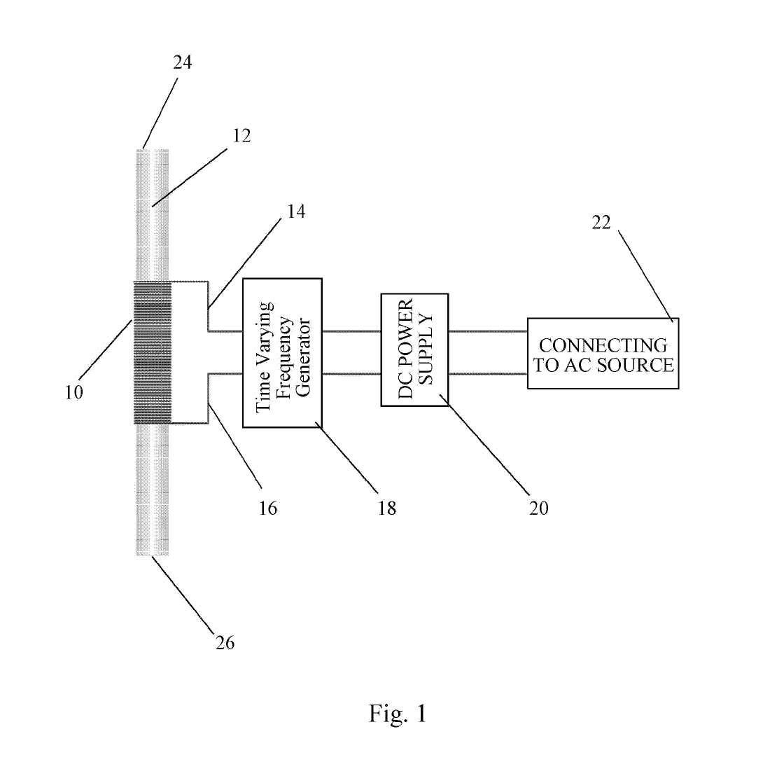

FIG. 1 shows a general arrangement of one embodiment of the present invention. In this arrangement, an induction coil 10 helically surrounds a conduit 12 with a predetermined gap defined by an inner diameter of the induction coil 10 and an outer periphery of the conduit 12. It would be apparent that the induction coil 10 does not come into contact with the conduit 12. The induction coil may be disposed at a selected position of the conduit or a position suitable for the coil in practice. Both ends 14, 16 of the induction coil 10 are connected to a time-varying frequency generator 18, or an analog or digital control circuit (not shown). The generator 18 is connected to a DC voltage source 20 to which a mains power supply 22 is converted by a rectifier circuit (not shown). The rectifier ensures that the current applied to the generator 18 is always direct current. The pulse generator 18 provides that the magnetic and electrical fields are pulsed at a time-varying frequency.

The conduit shown in FIG. 1 is made of a metal material, such as stainless steel 316L. It would be appreciated that a wide range of metallic or nonmetallic materials are suitable for the conduit of the invention, but not limited to the above embodiment.

Preferably, the conduit of the invention has a diameter of 10 to 1000 mm and a wall thickness of 0.1-20 mm. If the diameter is too small, then a magnetic flux not only passes through the interior of the conduit, but also covers over the outside of the conduit. This leads to the loss of magnetic flux, and therefore, the conduit of small diameter should be avoided as possible.

The ends 24, 26 can be connected to a tank for storing hydrocarbon fluids or a hydrocarbon fluid flowing system by thread connections or suitable flanges (e.g. welded or threaded flange). The treated hydrocarbon fluids are transferred to a fluid storage tank through a pump (not shown).

One or more temperature sensors (not shown) such as thermocouples may be arranged within the conduit to detect the temperature of the fluid in particular regions of the conduit. The readings of these sensors are used to control energising of the induction coil so as to maintain the temperature of the fluid to be treated to fall within the predetermined limits. Similarly, a viscometer (not shown) may be arranged within the conduit to measure the viscosity of the treated hydrocarbon fluid.

The induction coil helically surrounds the conduit. The number of turns of the coil is selected according to the requirement in practice, preferably in the range of 2 to 2000, and more preferably in the range of 150 to 180. The induction coil is made of copper wire have an outer diameter of 1 to 10 mm, preferably 2 to 5.5 mm. It is advantageous that the copper wire is electrically insulated. An insulating layer is applied to the inner surface of the induction coil and/or the outer surface of the conduit on which the induction coil is disposed to create the gap.

The pulse powered time-varying frequency generator, or the analog or digital control circuit produces time-varying electrical signals of manipulable frequency, waveform, and amplitude. In this embodiment, the frequencies range from 0.2 KHz to 200 KHz, the time-varying frequency sweeping timing varies from 1 ms to 10 sec., and the time-varying frequency wave is square, triangular or sinusoidal. The pulse powered time-varying frequency generator is connected to the DC voltage source to which a mains power supply is converted by a rectifier circuit. The DC voltages range from 3 to 48 volts, or higher voltage but within the safety limit.

The present invention can be embodied as described below. Referring to FIG. 1, a 48V of direct current supplied by the DC power supply 20 is applied to the time-varying frequency generator 18. The generator 18 then produces time-varying frequency current of square wave with the frequency of 5 to 20 KHz (preferably 12.5 kHz to 15 kHz), the current of 7 A to 15 A. For these time-varying frequencies, the sweeping timing of about 60 ms. The induction coil 10 is electrically excited such that heat in the conduit 12 is generated by electromagnetic induction, and the hydrocarbon fluid molecules are efficiently dissociated using pulsating electromagnetic fields. After being pre-magnetized for a period of time, preferably 5 to 20 minutes, the hydrocarbon fluid to be treated (e.g. heavy oil or light oil (Diesel oil, if needed)) enters from one end 24 of the conduit 12 into the conduit 12. The hydrocarbon fluid has already been heated and treated when it comes out from the other end 26 of the conduit. In this embodiment, the temperature of the surface of the conduit can rise from 25° C. to 100° C. in 20 minutes. It is well acknowledged that the induction heating would also help to reduce the viscosity of the hydrocarbon fluid.

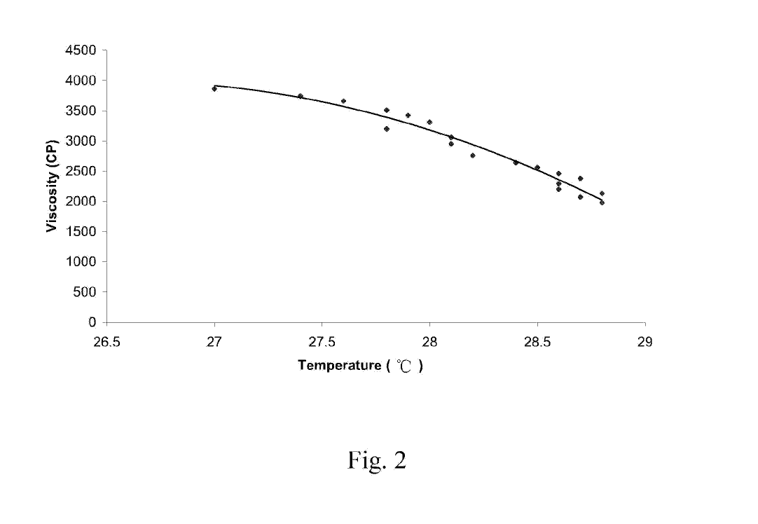

Taking 380 cSt grade hydrocarbon fluid, i.e., heavy oil as an example, the temperature of the hydrocarbon fluid treated (with heat isolation) as such is raised from about 27° C. to about 28.8° C. and its viscosity reduces from about 3800 cSt to about 2000 cSt, as shown in FIG. 2. In this test, heat generated from induction heating is isolated, and it has been confirmed that viscosity drops significantly after the treatment of invention despite of heat generated by induction heating. It would be obvious that the treatment of the heavy oil in combination of the induction heating would make the results much better, i.e., the viscosity of the heavy oil definitely decreases more quickly in a more shorter period of time.

In a further embodiment, a light fuel was treated under the same conditions as mentioned above. At the measured points, the temperature of the treated light fuel as such is raised from about 24.9° C. to about 38.4° C. within 5 minutes and its viscosity reduces from about 7.45 cSt to about 4.79 cSt. These results show that the treated fuel can move more efficiently and at a greater speed through pipelines, and that its stability in transportation, storage and refining processes is improved as a result of use of the pulsed electromagnetic technology according to the present invention.

Thus, the invention provides a method for treating a hydrocarbon fluid using pulsating electromagnetic wave in combination with induction heating. As described above, the method of the invention is characterized by the combined use of pulsating electromagnetic fields and induction heating, and therefore is energy efficient in preventing and reducing the viscosity of the fluids and the build-up of paraffin, asphaltene or the like. This method is able to eliminate the requirement for the magnetic field to be parallel and the electric field to be orthogonal in relation to the fluid flow, as well as to eliminate the need of having a non-magnetic conduit as disclosed in U.S. Pat. No. 5,899,220.

While the embodiments described herein are intended as an exemplary apparatus, it will be appreciated by those skilled in the art that the present invention is not limited to the embodiments illustrated. Those skilled in the art will envision many other possible variations and modifications by means of the skilled person's common knowledge without departing from the scope of the invention, however, such variations and modifications should fall into the scope of this invention.

1-17. (canceled)

18. A method for treating hydrocarbon fluids using pulsating electromagnetic wave in combination with inducting heating, comprising the steps of:
(a) mounting an induction coil onto a conduit having a central axis from which the hydrocarbon fluid to be treated flows, the induction coil being coaxially disposed with the conduit and having an inner diameter which forms a predetermined gap with an outer periphery of the conduit;
(b) subjecting the hydrocarbon fluid through the conduit; and
(c) applying a time-varying frequency current to the induction coil to produce pulsating electromagnetic field and induction heating around the induction coil, such that the combined effect of the pulsating electromagnetic field and the induction heating is induced in the fluid to prevent and/or reduce build-up of or natural deposition of paraffin, asphaltene or the like contained in the fluid and reduce a viscosity of the fluid in production lines, flow transmission lines, pipelines and oil storage.

19. The method according to claim 18, wherein the hydrocarbon fluids are light fuels.

20. The method according to claim 18, wherein the hydrocarbon fluids are heavy marine diesel oils.

21. The method according to claim 18, wherein the conduit is made of a metal or non-metallic material.

22. The method according to claim 21, wherein the conduit is made of stainless steel 316L.

23. The method according to claim 18, wherein the conduit has an outer diameter of 10-1000 mm and a wall thickness of 0.1-20 mm.

24. The method according to claim 19, wherein the conduit has an outer diameter of 10-1000 mm and a wall thickness of 0.1-20 mm.

25. The method according to claim 20, wherein the conduit has an outer diameter of 10-1000 mm and a wall thickness of 0.1-20 mm.

26. The method according to claim 21, wherein the conduit has an outer diameter of 10-1000 mm and a wall thickness of 0.1-20 mm.

27. The method according to claim 22, wherein the conduit has an outer diameter of 10-1000 mm and a wall thickness of 0.1-20 mm.

28. The method according to claim 18, wherein the induction coil helically surrounds the conduit and has the number of turns ranging from 2 to 2000.

29. The method according to claim 28, where the number of turns of the induction coil are in the range of from 150 to 180.

30. The method according to claim 18, wherein the induction coil is made of copper wire having an outer diameter from 1 to 10 mm.

31. The method according to claim 28, wherein the induction coil is made of copper wire having an outer diameter from 1 to 10 mm.

32. The method according to claim 29, wherein the induction coil is made of copper wire having an outer diameter from 1 to 10 mm.

33. The method according to claim 18, wherein an insulating layer is applied to an inner surface of the induction coil and/or an outer surface of the conduit on which the coil is disposed to create the gap.

34. The method according to claim 18, wherein the time-varying frequency current is supplied by a pulse powered time-varying frequency generator.

35. The method according to claim 34, wherein the generator is connected to a DC voltage source to which a mains power is converted by means of a rectifier circuit.

36. The method according to claim 35, wherein the DC voltages range from 3 to 48 volts.

37. The method according to claim 18, wherein the time varying frequency current is supplied by an analog or digital control circuit.

38. The method according to claim 34, wherein the frequency ranges from 0.2 KHz to 200 KHz.

39. The method according to claim 37, wherein the frequency ranges from 0.2 KHz to 200 KHz.

40. The method according to claim 34, wherein the time-varying frequency has a sweeping timing varying from 1 ms to 10 sec.

41. The method according to claim 37, wherein the time-varying frequency has a sweeping timing varying from 1 ms to 10 sec.

42. The method according to claim 34, wherein the time-varying frequency wave is square, triangular or sinusoidal.

43. The method according to claim 37, wherein the time-varying frequency wave is square, triangular or sinusoidal.
